(19) United States
(12) Patent Application Publication
(10) Pub. No.: US 2014/0141805 A1
(43) Pub. Date: May 22, 2014

(54) Proximal Device Method and System Using a Mobile Communication Device

(71) Applicant: Russell Mirov, Los Altos, CA (US)

(72) Inventor: Russell Mirov, Los Altos, CA (US)

(73) Assignee: Google Inc., Mountain View, CA (US)

(21) Appl. No.: 13/425,931

(22) Filed: Mar. 21, 2012

Related U.S. Application Data
(60) Provisional application No. 61/468,922, filed on Mar. 29, 2011.

(51) Int. Cl. H04W 4/02

(52) U.S. Cl. 455/456.3

(57) ABSTRACT

Systems and methods for information exchange with a targeted beaconing device in a positioning system that includes locating a mobile communication device within a proximity of a plurality of beaconing devices and an enabling of a transmission of information from a beaconing device. A mobile communication device receives the transmitted information from the beaconing device and optionally displays the transmitted information, where the transmitted information from the beaconing device is associated with a context based on the targeted beaconing device.

### CROSS REFERENCE TO RELATED APPLICATIONS

This application claims the benefit of U.S. Provisional Application No. 61/468,922 filed Mar. 29, 2011, which is hereby incorporated by reference in its entirety.

### BACKGROUND

1. Field

Embodiments relate generally to the field of indoor location based information systems.

2. Background

Typical location based information systems depend on global positioning systems (GPS) to determine a geographic location and a remote database that contains information associated with a particular geographic location. However, GPS receivers generally rely on navigation signals broadcasted by satellites orbiting the Earth. Therefore, such receivers require an unobstructed line of sight to the satellites in order to provide reliable location information. Thus, GPS is typically used to establish locations in outdoor environments only and may not be suitable to indoor locations. However, indoor positioning systems (IPS) have been developed to locate and track objects within indoor environments, such as office buildings. Such systems generally use various wireless transmissions, for example, infrared (IR) or ultrasound signals, for location and tracking purposes.

However, existing solutions for indoor positioning require sophisticated infrastructures be deployed within an interior space of a building. For example, these solutions may require special wiring be installed in the building and/or an architectural analysis of the interior space be performed for purposes of mounting necessary equipment. Further, any devices used in such a solution may have to be configured prior to shipment, or at an early stage of assembly with at least some type of identification such as a pre-configured serial number or identifying token.

### BRIEF SUMMARY

Embodiments relate to methods and systems for configuring proximal devices in-situ. By allowing a proximal device to be configured on-site, rather than at the point of manufacture, the proximal devices can be manufactured as identical components. Embodiments provide a capability to configure proximal devices in-situ using a directed beam that also places the proximal device into a configuration mode.

In an embodiment, a method for information exchange with a beaconing device in a positioning system includes locating a mobile communication device within a proximity of a first targeted one of a plurality of beaconing devices and an enabling of a transmission of information from the first targeted one of a plurality of beaconing devices. The method continues by receiving, at the mobile communication device, the transmitted information from the first targeted one of a plurality of beaconing devices; and optionally displaying the transmitted information from the first targeted one of a plurality of beaconing devices on the mobile communication device, where the transmitted information from the first targeted one of a plurality of beaconing devices is associated with a context based on the first targeted one of a plurality of beaconing devices.

In another embodiment, a system for proximal device configuration includes a mobile communication device located within a proximity of a first targeted one of a plurality of beaconing devices where an enabling of a transmission of information from the first targeted one of a plurality of beaconing devices occurs. The system includes where the mobile communication device is configured to receive and optionally display the transmitted information from the first targeted one of a plurality of beaconing devices and where the transmitted information is associated with a context based on the first targeted one of a plurality of beaconing devices.

Embodiments may be implemented using hardware, firmware, software, or a combination thereof and may be implemented in one or more computer systems or other processing systems.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments of the invention will now be described, by way of example only, with reference to the accompanying drawings in which corresponding reference symbols indicate corresponding parts. Further, the accompanying drawings, which are incorporated herein and form part of the specification, illustrate the embodiments of the present invention and, together with the description, further serve to explain the principles of the invention and to enable a person skilled in the relevant art(s) to make and use the invention.

FIG. 1 is a diagram of an embodiment of an example of placement of multiple proximal devices in an interior space.

FIG. 2 is a diagram of an embodiment of an exemplary system for the communication between deployed proximal devices and a mobile communication device.

FIG. 3 is a process flowchart of an exemplary method for communicating between a proximally configurable device and a mobile communication device, according to an embodiment.

FIG. 4 is a diagram of an example computer system in which embodiments can be implemented.

The features of various embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Embodiments relate to proximal device configuration, also referred to a beaconing device configuration. While illustrative embodiments are described herein with reference to particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to affect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### I. System

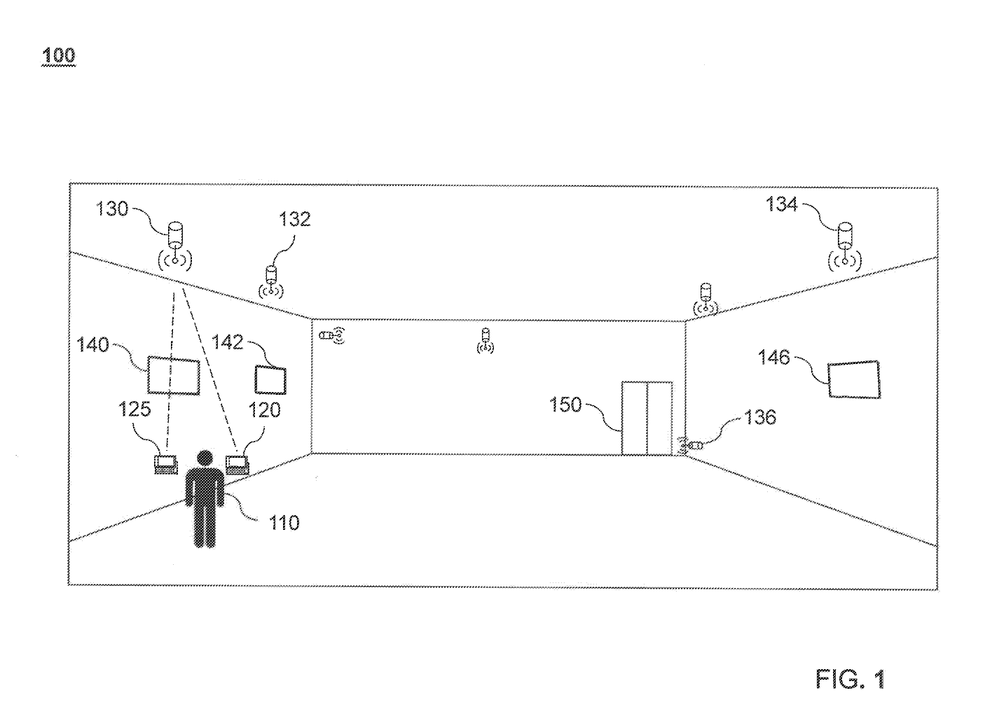

FIG. 1 is a diagram of an embodiment of an exemplary system 100 of multiple proximal devices and proximate items of interest located in an interior space. In the example shown in FIG. 1, system 100 includes a user 110, a mobile communication device 120, a proximal device configuration tool 125, and one or more proximally configurable devices 130, 132, 134 and 136. The system may further include objects of interest 140, 142 and 146, and a doorway 150.

Although proximally configurable devices 130, 132, 134 and 136 are labeled, FIG. 1 illustrates additional proximally configurable devices. There is no restriction as to the number or location of such proximally configurable devices. For example, a proximally configurable device can be located on a ceiling, a wall, or in the floor, in any orientation. Although FIG. 1 illustrates an indoor space, proximally configurable devices can be located outdoors as well in an embodiment. In an embodiment, proximally configurable devices 130, 132, 134 and 136 are beacon tags used to transmit information within a limited area. For example, user 110 could be viewing object of interest 140 that is located in proximity to proximally configurable device 130, and may be interested in additional information concerning object of interest 140. In an embodiment, by using mobile communication device 120, the user can receive additional information concerning object of interest 140 that is transmitted from proximally configurable device 130 where such information is stored within memory in proximally configurable device 130. The stored information can include additional information concerning object of interest 140 such as location, detail features, history, in-depth description, sales price, location coordinates, or any other possible associated information.

Proximally configurable devices from which mobile communication device 120 can receive signals may depend on factors such as the location of mobile device 120, and user 110, within the interior space relative to a proximally configurable device. For example, in an embodiment, user 110 could proceed to object of interest 142. In so doing, user 110 would be able to receive information from proximally configurable device 132. The received information could include information regarding object of interest 132, also referred to as a context, using mobile communication device 120. In a similar manner user 110 could proceed to object of interest 146 and receive context information from proximally configurable device 134 through mobile communication device 120 concerning object of interest 146. In an embodiment, user 110 may receive information about an object of interest from the proximally configurable device most proximate to the object or from another proximally configurable device. In an embodiment, user 110 may receive information from multiple proximally configurable devices.

Context information can include a variety of topics. For example, in a retail store setting a context can include inventory level information regarding specific products, or the context could refer to pricing information, e.g., a sale, as well as the location of a product within a store, e.g., aisle 3, section 2, shelf 1, or even location coordinate information, e.g., latitude, longitude, and/or elevation. Additional contexts can include information such as how an item is used, the nutritional value of a food item, and the like. There is no limitation or restriction associated with context information.

Context information can also refer to information associated with a geographic location. For example, in an embodiment, a proximally configurable device, such as proximally configurable device 136, contains geographic based context information. For example, if user 110 proceeds to exit the room through doorway 150, proximally configurable device 136 transmits context information to mobile communication device 120 regarding logistical information such as the name of the street located on the other side of the doorway, directions to other nearby attractions, or the user's location, or any other information that may be desirable to pass on to user 110 before user 110 leaves the current room. As an example, proximally configurable device 136 is shown mounted on a wall close to a floor. As previously mentioned, there is no restriction as to the location of a proximally configurable device. In addition, there is no restriction as to the type of information stored within each proximally configurable device.

Context information associated with a particular proximally configurable device may also be altered at any time. For example, a particular proximally configurable device may be associated with a store aisle that contains food, where the context is the nutritional value of a certain food item. At some point the store aisle may change how it is being stocked and no longer hold food items, but rather a hard good, e.g., a set of towels. The context information in the proximally configurable device associated with that aisle would simply be updated to contain a new set of context information, now relating to the new item on the shelf, e.g., the set of towels.

The arrangement of the proximally configurable devices, including proximally configurable devices 130, 132, 134 and 136, within the interior space shown in FIG. 1 provides only one example of an arrangement of proximally configurable devices within a space. Any number of arrangements, indoors or outdoors, may be used as necessary.

Mobile communication device 120 communicates with a plurality of proximally configurable devices 130, 132, 134 and 136. Mobile communication device 120 can be any type of mobile computing device having one or more processors, a memory, a user input device (for example, QWERTY keyboard, touch-screen, microphone, or a T9 keyboard), and a communications infrastructure capable of receiving and transmitting data over a network. Software may include one or more applications and an operating system. Hardware can include, but is not limited to, a processor, memory, and graphical user interface display. For example, mobile device 102 can include, but is not limited to, a mobile phone, a personal digital assistant (PDA), a laptop computer, a tablet computer, a netbook computer, an e-reader, or other similar type of mobile device capable of processing instructions and receiving and transmitting data.

Mobile communication device 120 is broadly defined to include any type of device that can be mobile with the ability to communicate. For example, mobile communication device 120 can include devices such as a robot, a vehicle, or any other type of mobile device with communication capabilities.

In another embodiment, a non-mobile device (not shown) communicates with a plurality of proximally configurable devices, e.g., proximally configurable devices 130, 132, 134 and 136. Such a non-mobile device can include devices such as an asset that is desired to be tracked, or a rarely moved item, e.g., a copying machine.

Although not shown in FIG. 1, mobile communication device 120 is capable of communicating with one or more servers over a network. Such servers can be implemented using any general-purpose computer capable of serving data to mobile communication device 120. The network can be any network or combination of networks used to communicate information between different computing devices. Such network can include, but is not limited to, a wired (e.g., Ethernet) or a wireless (e.g., Wi-Fi and 3G/4G) network. In addition, such network can include, but is not limited to, a local area network, medium area network, and/or wide area network such as the Internet.

In an embodiment, each proximally configurable device may be manufactured without any specific, unique programming or information, e.g., site specific information that would be transmitted to a user as described above. In such a scenario no special configuration or pre-programming is necessary prior to installation or placement of an individual proximally configurable device.

In an embodiment, each proximally configurable device may be manufactured without any specific site related information, but may include other programming, e.g., unit serial number, date code, model number, etc.

In an embodiment, proximally configurable devices are relatively small, e.g., 1″×¾″×¼″, and are expected to continue to decrease in size, approaching approximately 3 mm×3 mm×1 mm and operate using either stored power or ambient light as a power source. In an embodiment, because the proximally configurable devices are so small they lack typical physical connections and thus communicate through non-contact mediums such as through radio frequency (RF) and/or optical methods. The transmission range of the proximally configurable devices is also limited due to the small size and power capabilities and therefore typically operates in the 1-2 meter range.

In another embodiment, each proximally configurable device derives its power through energy that is delivered to the device during configuration. In such a situation, both power and configuration data are transferred to the device during the configuration process. In another embodiment, each proximally configurable device obtains power through an external source such as ambient light, radiation from a point source or fixture, e.g., a light fixture, or other energy source, e.g., thermal, RF, vibration, electromagnetic, pressure, etc.

In an embodiment, each proximally configurable device operates independently in the sense that configuration and operating of one device is separate and distinct from the configuration and operation of another device. Typically, each proximally configurable device is located such that a user would only be able to receive a transmission from a single proximally configurable device at any point in time as illustrated in FIG. 1 where user 110, at the location shown, can receive a signal from proximally configurable device 130, but not from proximally configurable devices 132, 134 and 136.

Configuration of each of the proximally configurable devices may also be accomplished independently, according to an embodiment. As such, each proximally configurable device can be configured with information unique to a particular proximally configurable device. FIG. 1 illustrates a user 110 with proximal device configuration tool 125 that can be used for in-situ configuration, according to an embodiment. FIG. 1 shows eight (8) different proximally configurable devices that have been located throughout a room. In an embodiment, all eight (8) devices are essentially identical and contain no information relating to their installed location, at the time of installation. Proximal device configuration tool 125 is used to connect individually with each targeted proximally configurable device in order to upload information to the device that the device stores and can later transmit a portion, or the entire amount, of information where users, via mobile communication devices, can receive the transmitted information when those users are within the broadcasting range of the proximally configurable device. In an embodiment, proximally device scanner 125 is a fixed position device. In another embodiment, proximally device scanner 125 is a mobile device.

In an embodiment, proximal device configuration tool 125 can send a directed beam, e.g., a laser beam, to a targeted proximally configurable device 130 in order to place proximally configurable device 130 into a programming mode. While in the programming mode information in proximal device configuration tool 125 can be uploaded and stored in proximally configurable device 130 for later retrieval by another device, such as mobile communication device 110. In a similar manner, proximal device configuration tool 125 can be directed to send a directed beam to proximally configurable device 132 in order to place proximally configurable device 132 into a programming mode in which information in proximal device configuration tool 125 can be uploaded and stored in proximally configurable device 132 for later retrieval by another device, such as mobile communication device 110. This process can be repeated until all the desired proximally configurable devices have been programmed to store the desired information in each device. The stored information can be unique in each proximally configurable device, but there is no such requirement that the information must be unique.

In an embodiment, proximally configurable device 130 monitors the environment for the presence of a beam or signal. In an embodiment, upon detecting such a beam, the proximally configurable device will receive instruction information within the directed beam that instructs proximally configurable device 130 to enter a configuration mode. Once in the configuration mode, proximally configurable device 130 can receive information, where such transmitted information can be uploaded through the directed beam. The transmitted information can include specific location based information or other configuration based information. In another embodiment, proximally configurable device 130 monitors the environment for the presence of a beam or signal, but will only enter a configuration mode after receiving the instruction information if the power level, or strength, of the directed beam is above a certain threshold. For example, proximally configurable device 130 can monitor the environment for the presence of light where light, e.g., a flash unit, is used to convey information specific to a particular proximally configurable device such as location or other configuration based information. However, proximally configurable device 130 is designed to enter a configuration mode only if the light is bright, e.g., over 500 lumens, otherwise proximally configurable device 130 will not enter a configuration mode, even if a proper set of instruction information is received. In an embodiment, instruction information is not required to enter into the configuration mode, but rather the detection of a directed beam with a power level above a threshold is sufficient to instruct proximally configurable device 130 to enter the configuration mode.

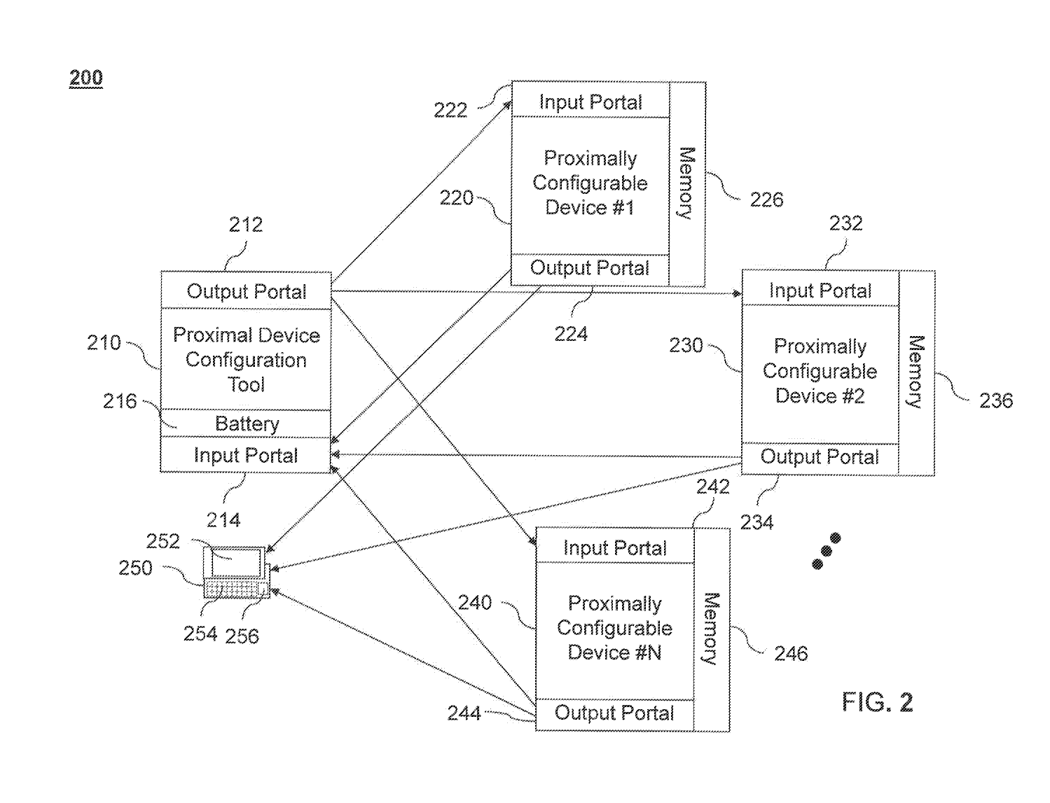

FIG. 2 is a diagram of an embodiment of an exemplary system 200 that includes a set of proximally configurable devices 220, 230 and 240 with a proximal device configuration tool 210 and a mobile communication device 250. As mentioned previously, it should be noted that any number of proximally configurable devices may be used as necessary as indicated by proximally configurable device 240 labeled “Proximally Configurable Device #N” where N is an integer greater than 1. in the example shown in FIG. 2, proximal device configuration tool includes an output portal 212 and an input portal 214 as well as other components apparent to a person skilled in the art that may include additional components, modules, and/or sub-components as may be necessary. Proximally configurable devices 220, 230 and 240 include input portals 222, 232, and 242 respectively, output portals 224, 234, and 244 respectively, and memories 226, 236, and 246, respectively. Mobile communication device 250 includes a display 252, input keyboard 254, and pointing device 256.

In an embodiment, proximally configurable devices 220, 230 and 240 include one or more input portals, e.g., 222, 232 and 242. Each input portal can receive communications from another device, such as proximal device configuration tool 210. Each input portal can be configured to receive one or more types of communications medium including communications utilizing one or more mediums including, but not limited to optical, RF, electromagnetic, acoustic, pressure, and/or temperature. Furthermore, each input portal may receive communications using multiple types of medium.

In an embodiment, proximally configurable devices 220, 230 and 240 include one or more output portals, e.g., 224, 234 and 244. Each output portal offers a non-contact device for sending communications to another device, such as proximal device configuration tool 210 or mobile communication device 250. Each output portal can be configured to transmit one or more types of communications including communications utilizing one or more mediums including, but not limited to optical, RF, electromagnetic, acoustic, and pressure. Furthermore, each output portal may transmit communications using multiple types of medium.

Input and output portals do not have to communicate using the same medium, according to an embodiment. For example, proximally configured device 220 can receive communications using input portal 222 where such communications are optically based, such as a laser, but transmit communications using output portal 224 where the outgoing communications are RF based.

Memory 226, 236 and 246 in proximally configurable devices 220, 230 and 240 respectively, store received information as well as information to be transmitted, according to an embodiment. Proximal device configuration tool 210 transfers information from output portal 212 to an input portal of a proximally configurable device, e.g., input portal 222 of proximally configurable device 220. This may be accomplished by proximal device configuration tool 210 transmitting a configuration enabling sequence, e.g., instruction information, to a proximally configurable device whereby the device recognizes the data as configuration data. In an embodiment, proximal device configuration tool 210 can also include an internal power source, such as battery 216. Proximal device configuration tool 210 can be any type of device with the ability to generate any type of non-contact medium. In an embodiment, proximal device configuration tool could include a mobile communication device with an embedded flash unit where the flash unit can be enabled in a certain sequence to convey configuration data, or any other information, to a proximally configurable device.

Such received information can include for example, whether the proximally configurable device should operate in a passive or active mode, according to an embodiment. In an embodiment, a passive mode is where the proximally configurable device is configured to transmit a communication from its output portal without a specific request, e.g., from detector or other device, but rather bases the decision to transmit information based on another factor, such as time, e.g., every 1 minute or on a continuous basis, which may occur at predetermined, regular or irregular intervals. In another embodiment, a passive mode is configured to be where the proximally configurable device senses a user, e.g., sensing a temperature, pressure or electromagnet radiation, and based on that detection transmits a communication from its output portal. In an embodiment, an active mode can be configured such that a proximally configured device transmits information from its output portal only upon the receipt of some type of communication by its input portal. Proximal device configuration tool 210 can also configure a proximally configurable device to operate in a hybrid active/passive mode responding to specific requests for information while also sending information based on a detection or time base as described above.

Configuration data can also include information associated with a context as previously described.

Mobile communication device 250 receives transmissions from an output portal of a proximally configurable device, e.g., 224, 234, or 244, in an embodiment. Mobile communication device 250 receives such communication while located within the proximity of a proximally configurable device. Such communication can be enabled in an active, passive, or hybrid mode as previously discussed. In an embodiment, mobile communication device 250 displays the communicated information, e.g., information associated with a context, on screen 252.

In an embodiment, mobile communication device 250 can be located in proximity to multiple proximally configurable devices. In such a situation mobile communication device 250 may receive and display information from each proximally configurable device in which mobile communication device 250 is proximally located.

Proximal device configuration tool, in an embodiment, has the ability to charge a proximally configurable device during configuration. In an embodiment, this transfer of power during configuration is the only source of power for a proximally configurable device. For example, proximal device configuration tool 210 communicates with proximally configurable device 220 by producing a laser beam in output portal 212. In another embodiment, proximal device configuration tool 210 communicates with proximally configurable device 220 by pulsating a light emitting diode (LED) beam in output portal 212. The laser, or LED, are examples of using light as a non-contact medium, to not only carries the information to be transferred to proximally configurable device 220, but the light itself can be a source of energy. Input portal 222 receives the light and retrieves the imposed information and also uses the light as a source of energy to charge its batteries (not shown).

### II. Method

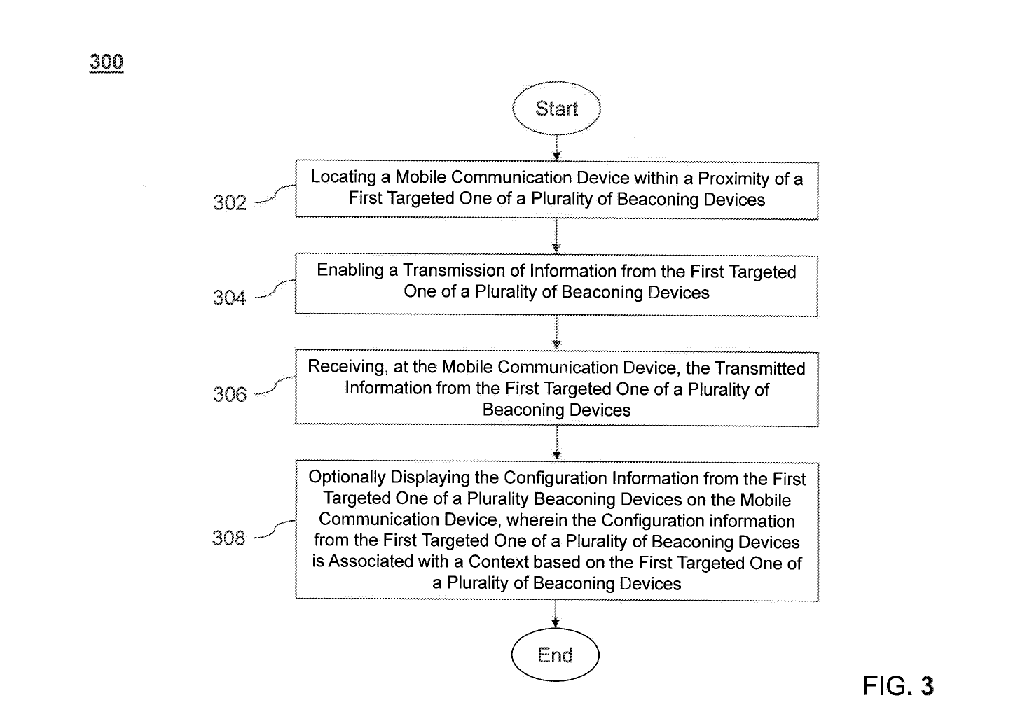

FIG. 3 is a process flowchart of an exemplary method 300 for information exchange with a beaconing device in a positioning system, according to an embodiment. Method 300 includes steps 302, 304, 306 and 308. For ease of explanation, system 100 of FIG. 1 and proximal device configuration tool 120, as described above, will be used to describe method 300, but is not intended to be limited thereto.

Method 300 begins in step 302, in which a mobile communication device is located in proximity to a first targeted one of a plurality of beaconing devices. FIG. 1 illustrates the placement of a plurality of proximally configurable devices, e.g., beaconing devices, in an interior space and a mobile communication device. The number and placement of proximally configurable devices in FIG. 1 is exemplary only. Exact placement of each proximally configurable device may be dependent upon the application in which the devices are intended to be used. FIG. 1 illustrates the example of placing three proximally configurable devices, e.g., 130, 132 and 134, each one near an object of interest in which each proximally configurable device can be configured to store a context, e.g., information relating to each of the respective objects of interest. In addition, proximally configured device 136 is located next to a doorway leading to another location and can be configured to transmit information related to a user proceeding through the doorway (e.g., into or out of a room or area).

The targeted beaconing device, prior to initially being configured, typically contains no unique identifying configuration data. For example, in an embodiment each of the deployed proximally configurable devices has not yet been configured and as such each device is essentially identical to the others. Once a beaconing device is placed at the desired location, that device can be configured with information applicable to the deployed location e.g., a context associated with a particular beaconing device. As described above, a proximal device configuration tool can be used to configure each unit where the information conveyed to each unit may be unique, but is not required to be unique. Configuration may be accomplished using a directed beam that can include any method of transmission that is not a physical connection, especially given that the proximally configurable devices can be too small to readily be configured with physical contacts.

For example, in an embodiment, mobile communication device 120 is proximally located with proximally configurable device 130, but not in proximity with proximally configurable device 134. In another embodiment, mobile communication device 120 can be considered to be proximally located with proximally configurable devices 130 and 132.

Method 300 proceeds to step 304, which includes the enabling of a transmission of information from the first targeted one of a plurality of beaconing devices. As previously discussed, a proximally configurable device can be configured to operate in a passive or active mode, according to an embodiment, where in a passive mode the proximally configurable device is configured to transmit a communication from its output portal without a specific request, e.g., from a mobile communication device, detector, or other device, but rather where the decision to transmit information is based on another factor, such as time, e.g., every 1 minute or on a continuous basis, which may occur at predetermined, regular or irregular intervals. In an embodiment, a passive mode is configured to be where the proximally configurable device senses a user, e.g., sensing a temperature, pressure or electromagnet radiation, and based on that detection transmits a communication from its output portal. In an embodiment, an active mode can be configured such that a proximally configured device transmits information from its output portal only upon the receipt of some type of communication by its input portal, e.g., a transmission from a mobile communications device.

Method 300 proceeds to step 306, which includes receiving, at the mobile communication device, the transmitted information from the first targeted one of a plurality of beaconing devices. Such transmitted information can include for example, whether the proximally configurable device should operate in a passive, active mode, or hybrid mode, along with any other type of configuration instructions that govern how the proximally configurable device is to operate. In addition, configuration data can also include information associated with a context, such as location, as previously described.

Method 300 proceeds to step 308, which includes optionally displaying the transmitted information from the first targeted one of a plurality of beaconing devices on the mobile communication device, wherein the transmitted information from the first targeted one of a plurality of beaconing devices is associated with a context based on the first targeted one of a plurality of beaconing devices. The display of information can be any type of display including, text, graphic, or sound or any other method of conveying information. Context information, as previously discussed, can refer to an object of interest, area, or geographical or location based information. Method 300 then concludes.

### III. Example Computer System Implementation

Aspects of the present invention shown in FIGS. 1-3, or any part(s) or function(s) thereof, may be implemented using hardware, software modules, firmware, tangible computer readable media having instructions stored thereon, or a combination thereof and may be implemented in one or more computer systems or other processing systems.

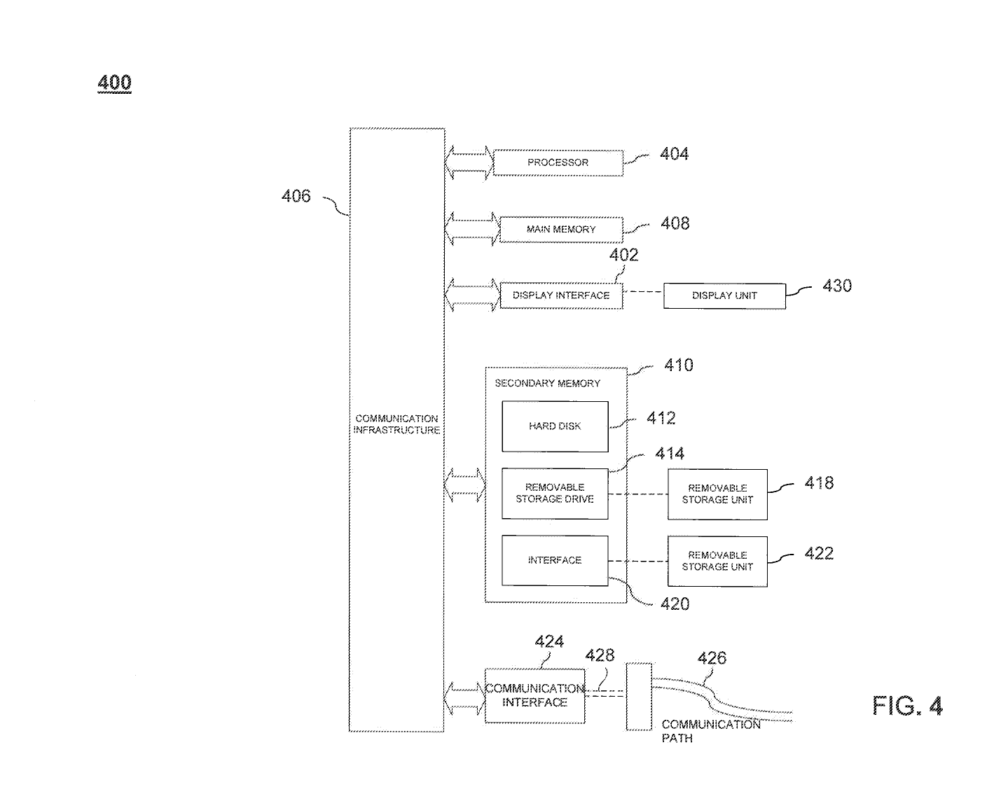

FIG. 4 illustrates an example computer system 400 in which embodiments, or portions thereof, may be implemented as computer-readable code. For example, portions of system 100, e.g., mobile communication device 120, portions of proximal device configuration tool 125, and portions of proximally configurable devices 130, 132, 134 and 136, may be implemented in computer system 400 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof Processor devices may have one or more processor “cores.”

Various embodiments of the invention are described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device. As will be appreciated by persons skilled in the relevant art, processor device 404 may also be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, removable storage drive 414. Removable storage drive 414 may include a floppy disk drive, a magnetic tape drive, an optical disk drive, a flash memory, or the like. The removable storage drive 414 reads from and/or writes to a removable storage unit 418 in a well-known manner. Removable storage unit 418 may include a floppy disk, magnetic tape, optical disk, etc. which is read by and written to by removable storage drive 414. As will be appreciated by persons skilled in the relevant art, removable storage unit 418 includes a computer usable storage medium having stored therein computer software and/or data.

Computer system 400 (optionally) includes a display interface 402 (which can include input and output devices such as keyboards, mice, etc.) that forwards graphics, text, and other data from communication infrastructure 406 (or from a frame buffer not shown) for display on display unit 430.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communication interface 424. Communication interface 424 allows software and data to be transferred between computer system 400 and external devices. Communication interface 424 may include a modem, a network interface (such as an Ethernet card), a communication port, a PCMCIA slot and card, or the like. Software and data transferred via communication interface 424 may be in the form of signals, which may be electronic, electromagnetic, optical, or other signals capable of being received by communication interface 424. These signals may be provided to communication interface 424 via a communication path 426. Communication path 426 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 418, removable storage unit 422, and a hard disk installed in hard disk drive 412. Computer program medium and computer usable medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communication interface 424. Such computer programs, when executed, enable computer system 400 to implement the present invention as discussed herein. In particular, the computer programs, when executed, enable processor device 404 to implement the processes of the present invention, such as the stages in the method illustrated by flowchart 300 of FIG. 3 discussed above. Accordingly, such computer programs represent controllers of the computer system 400. Where the invention is implemented using software, the software may be stored in a computer program product and loaded into computer system 400 using removable storage drive 414, interface 420, and hard disk drive 412, or communication interface 424.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### IV. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method for information exchange with a beaconing device in a positioning system, comprising:
locating a mobile communication device within a proximity of a first targeted one of a plurality of beaconing devices;
enabling the first targeted one of a plurality of beaconing devices through the receipt of an enabling sequence of data by the first targeted one of a plurality of beaconing devices; and
transmitting information from the enabled first targeted one of a plurality of beaconing devices;
wherein the transmitted information from the first targeted one of a plurality of beaconing devices is associated with a context based on the first targeted one of a plurality of beaconing devices.

2. The method of claim 1, further comprising displaying the transmitted information from the first targeted one of a plurality of beaconing devices on the mobile communication device.

3. The method of claim 1, wherein the enabling comprises a passive mode.

4. The method of claim 3, wherein enabling in a passive mode is based on time.

5. The method of claim 1, wherein the enabling comprises an active mode.

6. The method of claim 5, wherein the enabling in an active mode comprises a transmission of a sequence of data from the mobile communication device.

7. The method of claim 1, wherein the enabling comprises a hybrid active/passive mode.

8. The method of claim 1, wherein the context comprises information based on a retail product.

9. The method of claim 1, wherein the first targeted one of a plurality of beaconing devices receives unique configuration information as compared to a non-targeted plurality of beaconing devices.

10. The method of claim 1, further comprising:
locating the mobile communication device within the proximity of a second targeted one of a plurality of beaconing devices;
enabling the second targeted one of a plurality of beaconing devices through the receipt of an enabling sequence of data by the second targeted one of a plurality of beaconing devices; and
transmitting information from the second targeted one of a plurality of beaconing devices;
wherein configuration information from the second targeted one of a plurality of beaconing devices is associated with a context based on the second targeted one of a plurality of beaconing devices.

11. A system for information exchange with a beaconing device in a positioning system, comprising:
a mobile communication device located within a proximity of a first targeted one of a plurality of beaconing devices to enable a transmission of information to the first targeted one of a plurality of beaconing devices;
wherein the enabling comprises the first targeted one of a plurality of beaconing devices receiving an enabling sequence of data;
wherein the mobile communication device is configured to receive and display transmitted information from the first targeted one of a plurality of beaconing devices; and
wherein the transmitted information is associated with a context based on the first targeted one of a plurality of beaconing devices.

12. The system of claim 11, wherein the enabling comprises a passive mode.

13. The system of claim 12, wherein enabling in a passive mode is based on time.

14. The system of claim 11, wherein the enabling comprises an active mode.

15. The system of claim 14, wherein the enabling in an active mode comprises a transmission of a sequence of data from the mobile communication device.

16. The system of claim 11, wherein the enabling comprises a hybrid active/passive mode.

17. The system of claim 11, wherein the context comprises information based on a retail product.

18. The system of claim 11, wherein the first targeted one of a plurality of beaconing devices receives unique configuration information as compared to a non-targeted plurality of beaconing devices.

19. The system of claim 11, wherein:
the mobile communication device is located within the proximity of a second targeted one of a plurality of beaconing devices in which occurs an enabling of a transmission of information from the second targeted one of a plurality of beaconing devices;
the mobile communication device is configured to receive and display the transmitted information from the second targeted one of a plurality of beaconing devices; and
the transmitted information is associated with a context based on the second targeted one of a plurality of beaconing devices.
